(19) United States
(12) Patent Application Publication
(10) Pub. No.: US 2009/0104985 A1
(43) Pub. Date: Apr. 23, 2009

(54) GAMING SYSTEM IN WHICH A PLURALITY OF SLOT MACHINES SCRAMBLE FOR AWARDS

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE Corp., Tokyo (JP)

(21) Appl. No.: 12/256,320

(22) Filed: Oct. 22, 2008

(30) Foreign Application Priority Data
Oct. 22, 2007 (JP) 2007-273408

(51) Int. Cl. A63F 9/24; A63F 13/00

(52) U.S. Cl. 463/27

(57) ABSTRACT

Players of slot machines connected to a game server, by touching a fight button displayed on a liquid crystal panel via a touch panel, can participate in a scrambling game operated by the game server on condition that point amount owned by each player be bet. The game server, on the other hand, sets winning rates in the scrambling game by proportional distribution according to point amounts bet by players of slot machines to determine a winner/loser of the scrambling game.

### CROSS-REFERENCE TO RELATED APPLICATIONS

This application claims priority from the prior Japanese Patent Application No. 2007-273408 filed on Oct. 22, 2007, the disclosure of which is herein incorporated by reference in its entirety.

### BACKGROUND

1. Field

The present invention relates to a gaming system in which a plurality of slot machines scramble for awards.

2. Description of Related Art

As an example of a gaming system that has been conventionally used, there is a gaming system in which a plurality of slot machines share one progressive jackpot. In this gaming system, a portion of a bet of a unit game is accumulated in a jackpot fund whenever a unit game is conducted in each slot machine. If a specific winning combination is realized at a unit game of an arbitrary slot machine, the jackpot fund is awarded to the applicable slot machine. After that, the jackpot fund is reset. Accordingly, in the gaming system, the plurality of slot machines scramble for the jackpot fund.

Related art document information related to a gaming system in which awards are scrambled for among players using a network includes, for example, US Patent Laid-Open No. 2001/0049303 and U.S. Pat. No. 6,293,865. Related art document information related to a method or system for a lottery game in which a plurality of players can participate in a second game via a network includes, for example, US Patent Laid-Open No. 2006/0205476.

However, even though a portion of a player's own bet is accumulated in the jackpot fund, only a portion of the bet that corresponds to less than one percent or several percents of the bet at the most is shifted in the jackpot fund. For this reason, even though the jackpot fund is awarded, a player feels neither the player has taken other players' bets nor the player's own bet has been taken.

Moreover, the jackpot fund is awarded to each slot machine after a specific winning combination being realized. Accordingly, there is a tendency that a player of each slot machine does not think a slot game as a game where the plurality of slot machines scramble for a jackpot fund but thinks the slot game as a game that is individually conducted by the plurality of slot machines, with respect to the progressive jackpot.

### SUMMARY

Thus, the present disclosure has been made in view of the above respects and an object thereof is to provide a gaming system capable of clearly showing to each player a game on which awards of each player are bet among slot machines together with varying winning rates.

To achieve the object of the disclosure, there is provided a gaming system, comprising: game clients constituted by a plurality of slot machines; and a game server that manages each of the game clients, wherein each of the game clients has an input device and is programmed to execute the following processes (a) to (c) of (a) if a particular winning combination is realized during a slot game, pooling an amount of credit awarded for the particular winning combination as a fight fund separately from other credit and awarding a participation right in a scrambling game in which a total amount of the fight fund is bet; (b) if data indicating that the participation right is executed is input by a player through the input device, transmitting entry information including a notification of participation of the game client in the scrambling game and the total amount of the fight fund of pooled by the game client to the game server; and (c) if the following game-win/lose information is received from the game server, calculating the total amount of credit based on the game-win/lose information, and the game server is programmed to execute the following processes (α) to (ε) of: (α) if the entry information is received, determining the game client that has transmitted the entry information as a participant of the scrambling game; (β) if a number of game clients determined by the (α) as participants has reached a predetermined number, matching players of the scrambling game randomly from among game clients determined by the (α) as participants; (γ) distributing winning rates of the scrambling game proportionately according to an amount of the fight fund contained in the entry information transmitted by each of the game clients matched by the (β) as players of the scrambling game and determining a winner/loser of the scrambling game based on the winning rates for each game client of players of the scrambling game; (δ) transmitting game-win/lose information notifying that the total amount of the fight fund of a slot machine is confiscated to the slot machine determined by the (γ) as a loser of the scrambling game; and (ε) transmitting game-win/lose information notifying that the total amount of the fight fund of a slot machine determined by the (γ) as a loser of the scrambling game is awarded to the slot machine determined by the (γ) as the winner of the scrambling game.

### BRIEF DESCRIPTION OF THE DRAWINGS

FIG. 1 is a view showing characteristics of a gaming system according to one embodiment of the present invention;

FIG. 2 is a system block diagram showing the gaming system;

FIG. 3 is an external perspective view of each slot machine;

FIG. 4 is a schematic view showing symbol columns drawn on each video reel;

FIG. 5 is a block diagram schematically showing an internal construction of entire slot machine;

FIG. 6 is a block diagram schematically showing an internal construction of a sub control board;

FIG. 7 is a payout table showing winning combinations and payout amounts thereof when a slot game is executed by using each video reel;

FIG. 8 is a view showing an image example displayed on the liquid crystal panel;

FIG. 9 is a view showing an image example displayed on the liquid crystal panel;

FIG. 10 is a view showing an image example displayed on the liquid crystal panel;

FIG. 11 is a view showing an image example displayed on the liquid crystal panel;

FIG. 12 is a view showing an image example displayed on the liquid crystal panel;

FIG. 13 is a view showing an image example displayed on the liquid crystal panel;

FIG. 14 is a view showing an image example displayed on the liquid crystal panel;

FIG. 15 is a view showing an image example displayed on the liquid crystal panel;

FIG. 16 is a flowchart of a main control program;

FIG. 17 is a flowchart of a main game process program;

FIG. 18 is a flowchart of a payout amount display process; and

FIG. 19 is a flowchart of a control program executed in between each gaming machine and a game server.

### DETAILED DESCRIPTION

[1. Outline of the Invention]

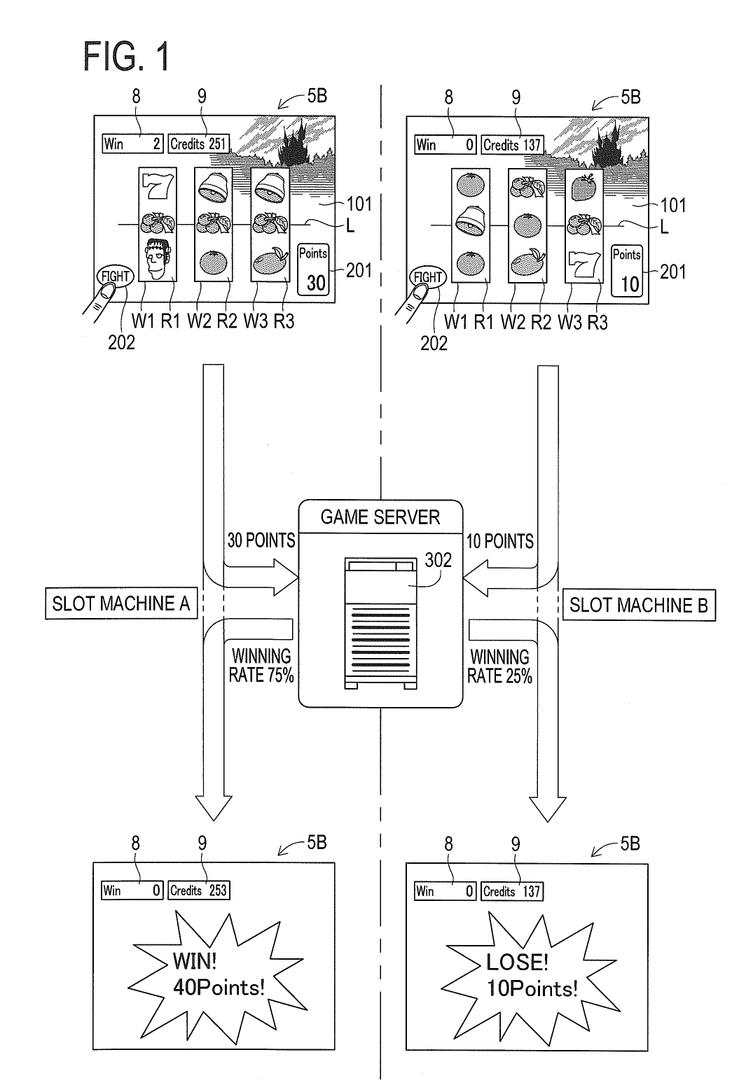

Hereinafter, embodiments of the invention will be described with reference to the accompanying drawings. In a gaming system according to this embodiment, a plurality of slot machines are connected to a game server through a network that enables bidirectional communication. FIG. 1 is a view showing the characteristics of a gaming system according to an embodiment of the invention.

FIG. 1 shows a slot machine A and a slot machine B as the plurality of slot machines connected to a game server 302. Each liquid crystal panel 5B provided in the slot machine A and the slot machine B is formed of a publicly known liquid crystal panel and a slot game is executed on the liquid crystal panel 5B.

In this respect, in each liquid crystal panel 5B, as shown in the upper part of FIG. 1, symbols of three video reels R1, R2, and R3 are arranged three by three on three display windows W1, W2, and W3. One pay line L, which horizontally crosses the display windows W1, W2, and W3, is displayed on each liquid crystal panel 5B. The pay line L is used to specify a combination of symbols. A touch panel 101 is provided in front of each liquid crystal panel 5B. Further, as shown in the upper and lower parts of FIG. 1, a payout amount display portion 8 and a credit amount display portion 9 are provided in each liquid crystal panel 5B.

During a slot game, on the other hand, various winning combinations are preset based on combinations of each symbol. Further, during a slot game, three symbols are rearranged on each display window W1, W2, and W3 by each video reel R1, R2, and R3 being rotated and stopped respectively. If, at this point, the combination of symbols constituted by three symbols rearranged on the pay line L corresponds to one of winning combinations, an amount obtained by multiplying the payout amount corresponding to the winning combination with the bet amount is displayed on the payout amount display portion 8. This constitutes a unit game of a slot game. The payout amount displayed on the payout amount display portion 8 is added and displayed on the credit amount display portion 9 when the unit game is finished.

In a gaming system according to the present embodiment, however, if a winning combination related to a symbol [CHERRY] is rearranged on the pay line L, an amount obtained by multiplying the payout amount corresponding to the winning combination with the bet amount is pooled separately. More specifically, an amount obtained by multiplying the payout amount corresponding to the winning combination related to the symbol [CHERRY] with the bet amount is added and displayed as point amount on a point display portion 201 provided in each liquid crystal panel 5B. Thus, the displayed point amount is distinguished from an amount obtained by multiplying the payout amount corresponding to other winning combinations with the bet amount.

Further, if a winning combination related to the symbol [CHERRY] is rearranged on the pay line L, a fight button 202 is displayed on each liquid crystal panel 5B. Then, if a player touches the fight button 202 via the touch panel 101, data for notification of participation in a scrambling game on which the point amount displayed on the point display portion 201 is bet is transmitted to the game server 302.

In FIG. 1, a player of the slot machine A touches the fight button 202 via the touch panel 101 when [30] is displayed on the point display portion 201 and thus, data for notification of participation in a scrambling game on which [30] points are bet is transmitted to the game server 302. A player of the slot machine B, on the other hand, touches the fight button 202 via the touch panel 101 when [10] is displayed on the point display portion 201 and thus, data for notification of participation in a scrambling game on which [10] points are bet is transmitted to the game server 302.

The game server 302, on the other hand, determines only one slot machine among slot machines playing against each other in the scrambling game as a winner and other slot machines as losers of the scrambling game. At this point, the game server 302 distributes probabilities of winning a scrambling game proportionally according to point amount bet by the player of each slot machine. If, for example, players of the slot machine A and the slot machine B play against each other in a scrambling game, as shown in FIG. 1, the game server 302 sets the winning rate of the slot machine A at 75% and that of the slot machine B at 25% because the player of the slot machine A bets [30] points and the player of the slot machine B bets [10] points.

Subsequently, when a winner and a loser in the scrambling game are determined, the total point amount bet by the player of the winning slot machine of the scrambling game and that bet by the other player is awarded to the winning slot machine and the point amount bet by the player of the losing slot machine of the scrambling game are confiscated. If the case shown in FIG. 1 is described as a concrete case, the game server 302 determines that the slot machine A is the winner of the scrambling game and the slot machine B the loser. Further, the game server 302 transmits data notifying the slot machine A that [40] points obtained by totaling [30] points bet by the player of the slot machine A and [10] points bet by the player of the slot machine B be awarded to the slot machine A and data notifying the slot machine B that [10] points bet by the player of the slot machine B be confiscated to the slot machine B.

Then, a screen shown, for example, in the lower part of FIG. 1 is displayed on each liquid crystal panel 5B of the slot machine A and the slot machine B. That is, on the liquid crystal panel 5B of the slot machine A, each display window W1, W2, and W3, each video reel R1, R2, and R3, and the pay line L are erased and instead, [WIN! 40 Points!] indicating that [40] points have been gained in a scrambling game is displayed. Although not shown in FIG. 1, [40] points are added and displayed on the credit amount display portion 9. Also on the liquid crystal panel 5B of the slot machine B, on the other hand, each display window W1, W2, and W3, each video reel R1, R2, and R3, and the pay line L are erased and instead, [LOSE! 10 Points!] indicating that [10] points have been lost in a scrambling game is displayed.

In this manner, in the present embodiment described below, the player of each slot machine can participate in a scrambling game in which a winner and losers are determined by the game server 302 on condition that each player bet all point amount that they own. In this case, the game server 302 distributes winning rates in a scrambling game based on the point amount bet by the player of each slot machine. Thus, winning rates in a scrambling game vary depending on the size relation between the point amount bet by a player and that bet by the other player.

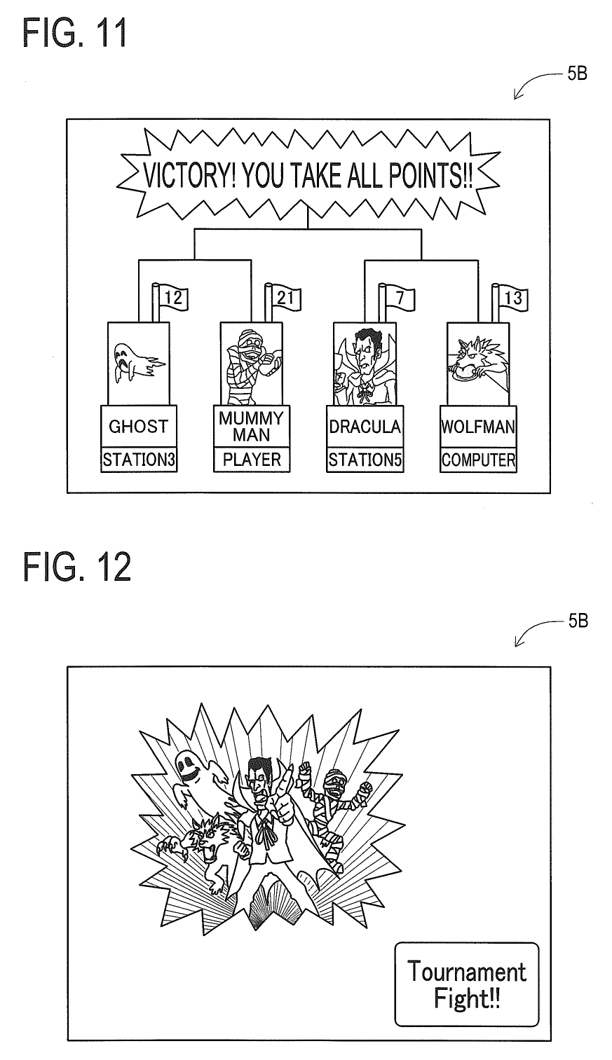

After receiving data indicating participation in a scrambling game from each slot machine within a predetermined time period, the game server 302 matches the other player of the scrambling game in a tournament play. Further, the game server 302 determines a winner and a loser of each match of the tournament by setting, as described above, wining rates. Then, only the slot machine that has survived the tournament gets all point amount bet on the scrambling game. However, if the number of wins needed to survive the tournament of a scrambling game is unfair, the game server 302 adds itself as a participant betting predetermined point amount when matching the other player of the scrambling game in the tournament play as many times as necessary until the unfairness is eliminated (refer to below FIG. 11).

[2. Schematic Structure of the Gaming System]

Hereinafter, one embodiment embodying the present invention is described with reference to the drawings.

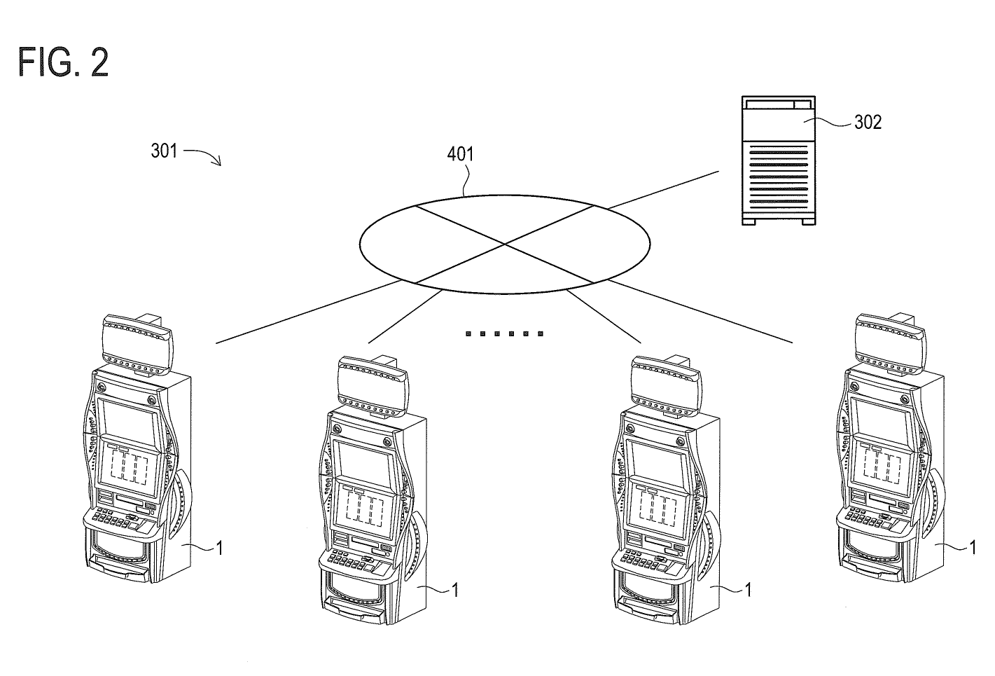

FIG. 2 is a system block diagram showing a gaming system 301 of the present embodiment. As shown in FIG. 2, the gaming system 301 of the present embodiment includes a network 401 of two-way communicable through which a game server 302 and a plurality of slot machines 1 are connected.

[3. Schematic Structure of Each Slot Machine]

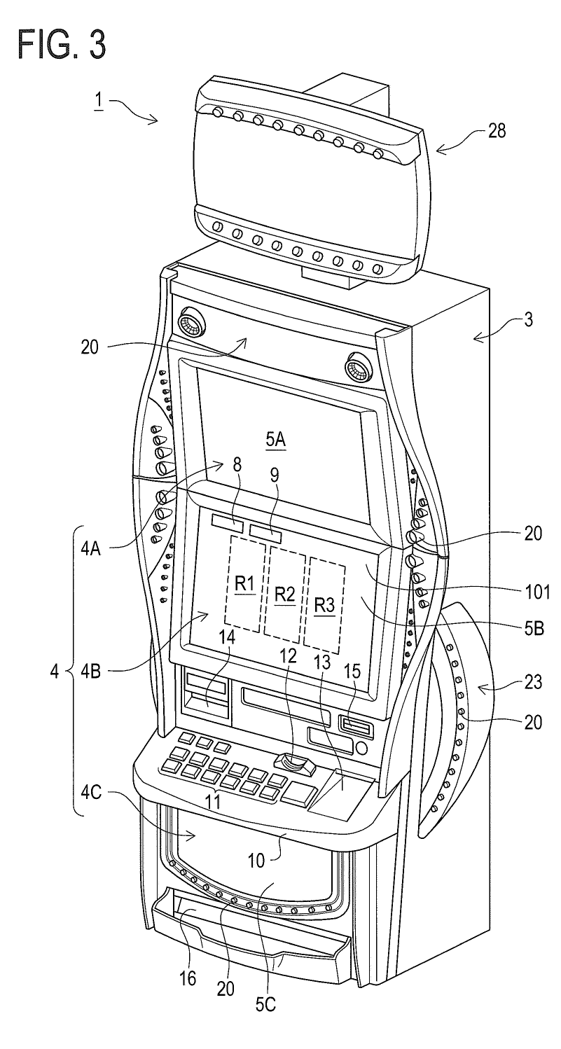

Next, a schematic structure of each slot machine 1 will be described by referring to FIG. 3. FIG. 3 is an external perspective view of each slot machine 1.

As shown in FIG. 3, each slot machine 1 is of an upright type which is equipped with a game arcade such as casino and includes a cabinet 3 for housing electric or mechanical parts for conducting predetermined types of games. A display unit 4 for displaying information related to a game includes, for example, an upper display unit 4A, a variable display unit 4B at the middle stage of the display unit 4, and an under display unit 4C, which are installed at the front face of the cabinet 3 in a vertically long shape. The upper display unit 4A includes a liquid crystal panel 5A arranged at the upper side of the variable display unit 4B, the liquid crystal panel 5A for displaying an effecting images, an introduction of a game, or an explanation of game rules and the like. The under display unit 4C is arranged at the lower side of the variable display unit 4B and includes a plastic panel 5C on which an image is printed. The plastic panel 5C is lighted up with the backlight of the under display unit 4C.

The variable display unit 4B for displaying a state of a game includes the liquid crystal panel 5B which is fixed at a front door of the cabinet 3. On the liquid crystal display panel 5B, the symbols of three video reels R1, R2 and R3 are rotated and stopped. In the middle variable display portion 4B, one pay line L horizontally crossing each of areas corresponding to the video reels R1, R1 and R3 is displayed on the liquid crystal display panel 5B.

Additionally, a touch panel 101 is provided on the front side of the liquid crystal panel 5B. A player may input his/her various instructions by operating the touch panel 101. On the upper position of the middle variable display portion 4B, the payout amount display portion 8 and the credit amount display portion 9 are arranged on the liquid crystal panel 5B. Also the upper portion of the middle variable display portion 4B, is related to the back side, thereby the player may play games in a cozy posture.

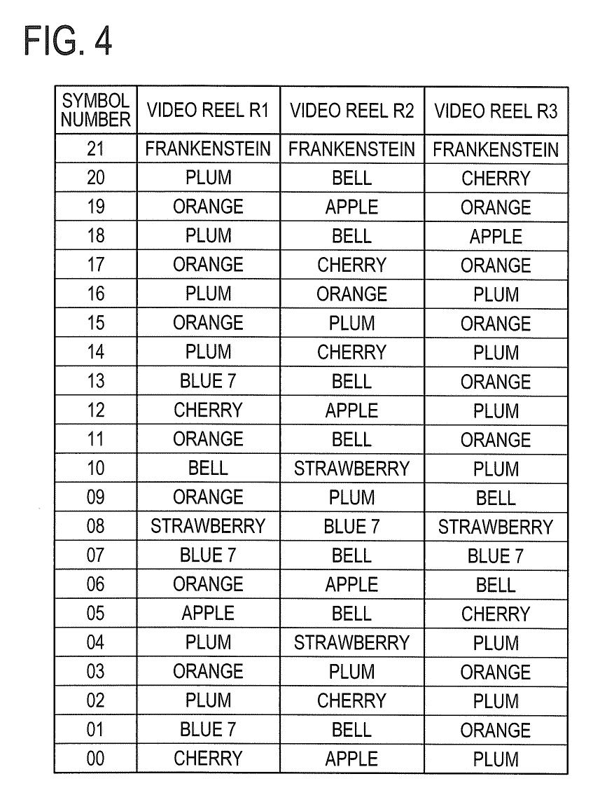

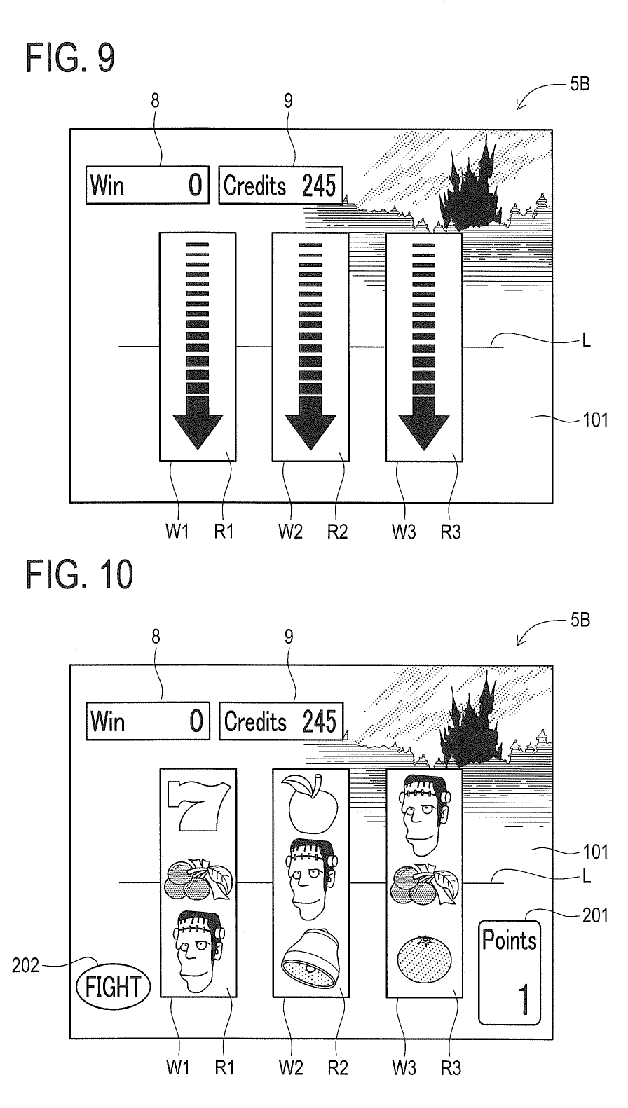

Here, the image of the slot game displayed on the liquid crystal panel 5B will be explained. FIG. 8 and FIG. 9 are the figures showing the contents displayed on the liquid crystal panel 5B. On each display window W1, W2 and W3 of the liquid crystal panel 5B, during the slot game, as shown in FIG. 8 and FIG. 9, the symbols drawn on the reel band of each video reel R1, R2, and R3 are displayed to be visible to a player. FIG. 8 shows the arranged or rearranged state of the symbols which are drawn on the reel band of each video reel R1, R2 and R3, on each display window W1, W2 and W3 of the liquid crystal panel 5B. FIG. 9 shows the rotating state of the symbols which are drawn on the reel band of each video reel R1, R2 and R3, on each display window W1, W2 and W3 of the liquid crystal panel 5B. On the reel band of each video reel R1, R2 and R3, a symbol column constructed from twenty-two symbol is drawn respectively (refer to FIG. 4).

On the liquid crystal panel 5B, the payout amount display portion 8 and the credit amount display portion 9 are arranged. On the payout amount display portion 8, the payout amount obtained during the slot game by the player is displayed. On the credit amount display portion 9, the credit amount which is owned by the current player is displayed. Also, on the payout amount display portion 8, the payout amount obtained in the free game by the player is displayed.

Therefore, on the each display window W1, W2 and W3 of the liquid crystal panel 5B during the slot game, three symbols which are drawn on the reel band of each video reel R1, R2 and R3 are arranged. On the liquid crystal panel 5B during the slot game, as shown in FIG. 8 and FIG. 9, the pay line L crossing each display window W1, W2 and W3 horizontally is displayed. The pay line L is used to specify the symbol combination.

Returning to FIG. 3, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button and the like are arranged as the operation portion to execute the game. On the operation table 10, a coin insertion slot 12 and a bill insertion portion 13 are arranged. Also between the operation table 10 and the middle variable display portion 4B, a ticket printer 14 and a card reader 15 are arranged. At the lowest position of the cabinet 3, a coin tray 16 is also arranged.

As to each slot machine 1, coins, bills or electronic value information (credit) corresponding to coins and bills are used as gaming media. However, in the present invention, types of gaming media are not restricted to the above. For example, medal, token, electronic money, ticket and the like are applicable as gaming media.

On the cabinet 3 of each slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

[4. Outline of the Symbols]

Next, the symbols drawn on the reel band of each video reel R1, R2 and R3 will be explained with reference to FIG. 4. These symbols are scrolled and rearranged on each display window W1, W2 and W3 of the liquid crystal panel 5B during the slot game and the free game. FIG. 4 is a schematic view schematically showing symbol columns drawn on the reel band of each video reel R1, R2 and R3.

On the reel band of each video reel R1, R2 and R3, twenty-two symbols are drawn respectively. Each symbol column is constructed from the symbols including [FRANKENSTEIN], [BLUE7], [BELL], [APPLE], [CHERRY], [STRAWBERRY], [PLUM] and [ORANGE]. And the symbols of the predetermined types are arranged in a predetermined sequence.

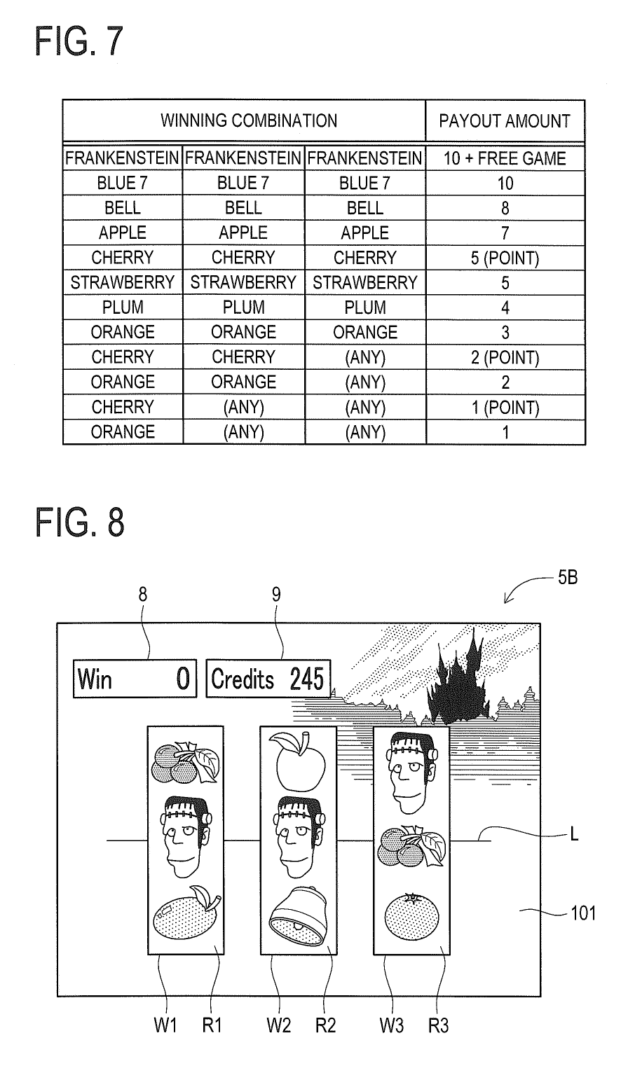

If three of any of the following symbols: [BLUE7], [BELL], [APPLE], [CHERRY], [STRAWBERRY], [PLUM] and [ORANGE] have been rearranged on the pay line L of the liquid crystal panel 5B, a payout amount obtained by multiplying a predetermined payout amount with a bet amount is awarded to a player (refer to FIG. 7). If one or two of symbols [CHERRY] or [ORANGE] have been rearranged on the pay line L of the liquid crystal panel 5B, a payout amount obtained by multiplying a predetermined payout amount with a bet amount is awarded to a player in accordance with the number of the rearranged symbols (refer to FIG. 7).

When three symbols of [FRANKENSTEIN] are rearranged on the pay line L of the liquid crystal panel 5B, a payout amount obtained by multiplying a predetermined payout amount with a bet amount is awarded to a player, and also the game shifts to a free game.

When a payout amount obtained by multiplying a predetermined payout amount with a bet amount is awarded to a player about the winning combination of the symbol [CHERRY], the payout amount corresponding to the winning combination of the symbol [CHERRY] is distinguished from the payout amount corresponding to other winning combinations and is pooled (except for the free game).

In each symbol sequence shown in FIG. 4, a symbol number is allocated with respect to each symbol constituting these symbol columns, starting from the top.

[5. Internal Configuration of Each Slot Machine]

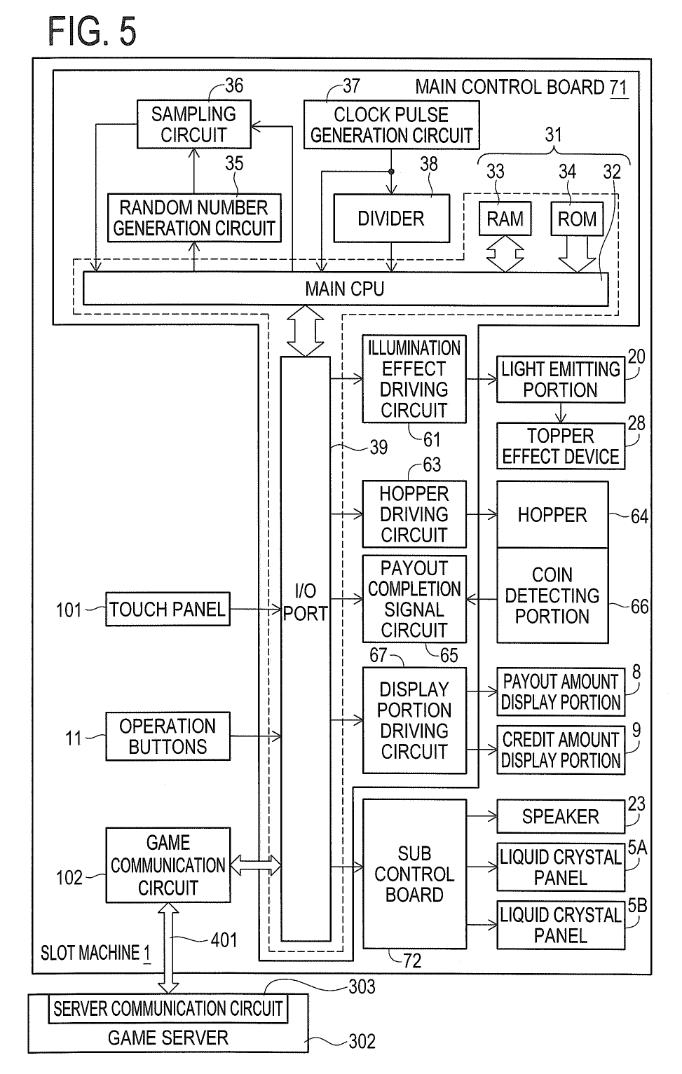

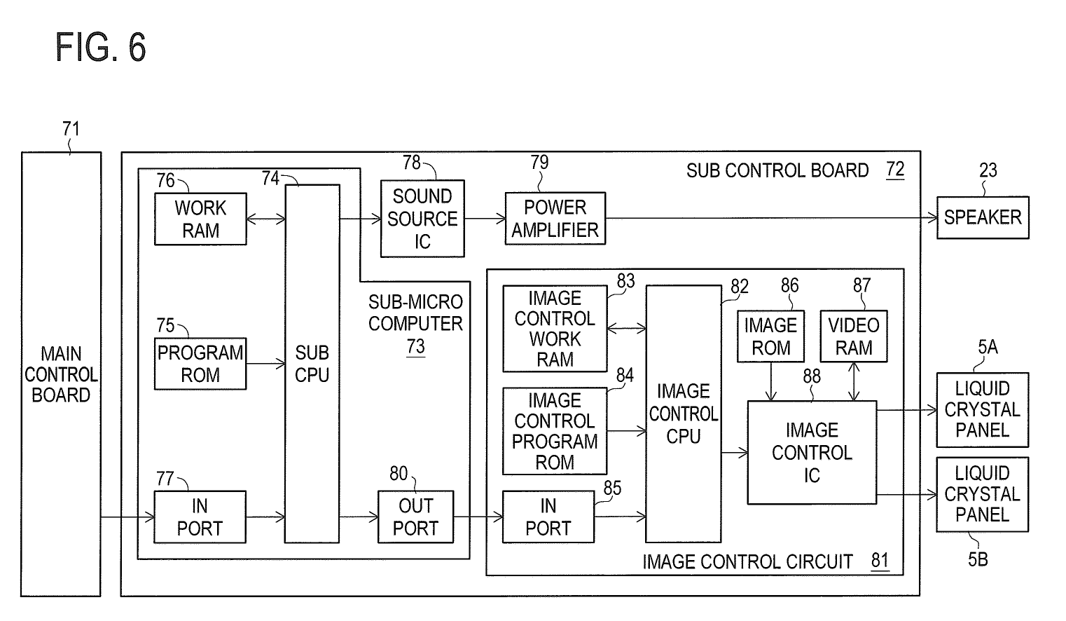

Next, the internal construction of the above slot machine 1 will be explained with reference to FIG. 5 and FIG. 6.

FIG. 5 is a block diagram schematically showing the internal construction of entire slot machine 1. As shown in FIG. 5, the slot machine 1 includes a plurality of construction elements such as a main control board 71, in which a microcomputer 31 is included. The main control board 71 is constructed from the microcomputer 31, a random number generation circuit 35, a sampling circuit 36, a clock pulse generation circuit 37 and a frequency divider 38. The main control board 71 also includes an illumination effect driving circuit 61, a hopper driving circuit 63, a payout completion signal circuit 65, a display portion driving circuit 67 and a game communication circuit 102.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code numbers of each video reel R1, R2 and R3, the symbol numbers are stored in the RAM 33. And the programs executed by the main CPU 32 and the permanent data are stored in the ROM 34.

Especially, the programs stored in the ROM 34 include the game programs and the gaming system programs (abbreviated as [the game programs and the like] hereinafter). And a lottery programs mentioned below is also included in the game programs.

The lottery program is a program used to determine the code numbers of each video reel R1, R2 and R3 which corresponds to each symbol rearranged on the pay line L of the liquid crystal panel 5B. In the lottery program, it is included symbol weighing data corresponding to each of plural kinds of payout rates (for example, 80%, 84%, and 88%). The symbol weighing data are the data indicating correlation between the code number of each reel and one or plural random numbers belonging to a predetermined number range (0 to 255), every each of the three video reels R1, R2 and R3. In other words, each of the code number of one reel is associated with one or more random numbers corresponding to the payout rate. The random number is extracted by the lottery program, and the symbol specified finally by the random number is rearranged on the pay line L of the liquid crystal panel 5B.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

Furthermore, the touch panel 101 is connected to the main control board 71. The touch panel 101 is arranged in front of the liquid crystal panel 5B, and specifies the coordinate position of the portion touched by the player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include the spin button, the collecting button, the BET button and the like. The signals corresponding to the pressing of these buttons are input to the main CPU 32 through I/O port 39.

The effect signals which are used to conduct illumination effect are output to the above-mentioned light emitting portion 20 and topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit amount display portion 9 is controlled by the display portion driving circuit 67.

The game communication circuit 102 is a device that converts a signal sent to be sent out by the slot machine 1 into a signal in a sendable format, according to transmission method of a phone line or a LAN cable, so as to send it to the game server 302. Conversely, the game communication circuit 102 receives a signal sent from the game server 302 to reconvert the signal into a signal in a format readable by the slot machine 1. The game communication circuit 102 is connected to a server communication circuit 303 via the network 401 of two-way communicable, such as the Internet.

Furthermore, a sub control board 72 is connected to the main control board 71. As shown in FIG. 6, commands from the main control board 71 are input to the sub control board 72. The display control on the liquid crystal panel 5A of the upper display portion 4A and the liquid crystal panel 5B of the variable display portion 4B, and the sound output control on the speaker 23 are executed by the sub control board 72. The sub control board 72 is constructed on a circuit board different from the circuit board for the main control board 71, and includes a microcomputer 73 (abbreviated as [sub-microcomputer] hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation circuit and a sampling circuit are not included in the sub control board 72, the sub control board 72 is constructed so as to execute random number sampling according to the operation programs thereof. The control programs executed by the sub CPU 74 are stored in the program ROM 75. The work RAM 76 is constructed as a temporary storing means when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing means when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. Therefore, the dot data related to the symbols drawn on the reel band of each video reel R1, R2 and R3 are stored in the image ROM 86. The video RAM 87 runs as a temporary storing means when the images are formed by the image control IC 88.

Further, the image control circuit 81 executes display control of the rotation display/stop display of the video reels R1, R2, and R3 on each display window W1, W2 and W3 of the liquid crystal panel 5B, based on control signals from the main CPU 32.

[6. Outline of the Slot Game]

Next, winning combinations and the payout amounts corresponding to the winning combinations will be explained with reference to FIG. 7, wherein the winning combinations are the symbol combinations when the slot game is executed by using each video reel R1, R2 and R3 in each slot machine 1. FIG. 7 is a payout table in which the winning combinations and the payout amounts corresponding to the winning combinations are shown when the slot game is executed by using each video reel R1, R2 and R3 in each slot machine 1.

Here, the payout amount shown in FIG. 7 indicates the payout amount when the bet amount is [1] during the slot game. Therefore, when the bet amount is [1], the payout amount shown in FIG. 7 is awarded, and when the bet amount is more than [2], the payout amount obtained by multiplying the payout amount shown in FIG. 7 with the bet amount is awarded.

Thereby, when three symbols of [FRANKENSTEIN] are rearranged on the pay line L of the liquid crystal panel 5B, the payout amount obtained by multiplying 10 credits with the bet amount is awarded. Additionally, the bonus trigger is realized, the free game is generated. Also, in the free game, the bonus trigger may be realized, at that time, a new free game is generated.

When three symbols of [BLUE 7] are rearranged on the pay line L of the liquid crystal panel 5B, the payout amount obtained by multiplying 10 credits with the bet amount is awarded.

When three symbols of [BELL] are rearranged on the pay line L of the liquid crystal panel 5B, the payout amount obtained by multiplying 8 credits with the bet amount is awarded.

The payout amount corresponding to each winning combination shown in FIG. 7, are set as the same in the above.

However, when a symbol combination constructed from the symbols rearranged on the pay line L of the liquid crystal panel 5B, is not any of the winning combinations shown in FIG. 7, the symbol combination is not a winning combination. Therefore, no credits may be awarded.

Further, during the slot game (except for the free game), when the winning combination of the symbol [CHERRY] are rearranged on the pay line L of the liquid crystal panel 5B, the payout amount obtained by multiplying the payout amount corresponding to the winning combination with the bet amount is distinguished from the payout amount obtained by multiplying the payout amount corresponding to other winning combinations with the bet amount and is awarded as point amount.

As mentioned above, in each slot machine 1, the slot game and the free game is executed.

In other words, during the slot game, a game is executed by rearranging a specific symbol combination by using each video reel R1, R2 and R3 on the pay line L of the liquid crystal panel 5B. During the slot game, firstly, a part of symbol column (three symbols) drawn on the reel band of each video reel R1, R2 and R3 shown in FIG. 4, is arranged on each window W1, W2 and W3 of the liquid crystal panel 5B (refer to FIG. 8). Here, after the player sets the bet amount by pressing the BET button among the operation buttons 11, if the player presses the spin button among the operation buttons 11, each video reel R1, R2 and R3 rotates, the symbol column drawn on the reel band of each video reel R1, R2 and R3 shown in FIG. 4, is scrolled from up to down and displayed on each window W1, W2 and W3 of the liquid crystal panel 5B (refer to FIG. 9).

After a predetermined time, each video reel R1, R2 and R3 stops automatically, a part of the symbol column (three symbols) drawn on the reel band of each video reel R1, R2 and R3 shown in FIG. 4, is rearranged on each window W1, W2 and W3 of the liquid crystal panel 5B (refer to FIG. 8). On the other hand, each winning combination based on each symbol combination is determined beforehand (refer to FIG. 7). When the symbol combination constructed from the three symbols rearranged on the pay line L of the liquid crystal panel 5B, realizes a winning combination, the payout amount obtained by multiplying the payout amount corresponding to the realized winning combination with the bet amount is awarded to the player.

On the other hand, in the free game, the game, in which a specific symbol combination is rearranged by using each video reel R1, R2 and R3 on the pay line L of the liquid crystal panel 5B, is repeated over a predetermined number of times. Also, in the free game, a part of the symbol column (three symbols) drawn on the reel band of each video reel R1, R2 and R3 as shown in FIG. 4, is arranged on each window W1, W2 and W3 of the liquid crystal panel 5B (refer to FIG. 8). However, here, after a predetermined time, each video reel R1, R2 and R3 rotates automatically. Thereby, no matter whether the player presses the operation buttons 11 such as the BET button or the spin button, the symbol column drawn on the reel band of each video reel R1, R2 and R3 as shown in FIG. 4 is scrolled from up to down and displayed on each window WI, W2 and W3 of the liquid crystal panel 5B (refer to FIG. 9).

Furthermore, after a predetermined time, each video reel R1, R2 and R3 stops automatically, a part of the symbol column (three symbols) drawn on the reel band of each video reel R1, R2 and R3 as shown in FIG. 4, is rearranged on each window W1, W2 and W3 of the liquid crystal panel 5B (refer to FIG. 8). On the other hand, similar to the above slot game, each kind of winning combination is determined beforehand based on the symbol combination (refer to FIG. 7). When the symbol combination, which is constructed from the three symbols rearranged on the pay line L of the liquid crystal panel 5B, realizes a winning combination, the payout amount obtained by multiplying the payout amount corresponding to the realized winning combination with the bet amount is awarded to the player.

The predetermined number of times for the free game (for example, 20 times) is set in advance.

[7. Outline of the Scrambling Game]As shown in FIG. 10, the point display portion 201 or the fight button 202 may be displayed on the liquid crystal panel 5B during the slot game. In this respect, a winning combination related to the symbol [CHERRY] being rearranged on the pay line L of the liquid crystal panel 5B is needed to display the point display portion 201 or the fight button 202 on the liquid crystal panel 5B. At this point, an amount obtained by multiplying the payout amount corresponding to the winning combination with the bet amount is displayed on the point display portion 201 as point amount.

Then, after the point display portion 201 or the fight button 202 is displayed on the liquid crystal panel 5B, each time a winning combination related to the symbol [CHERRY] is rearranged on the pay line L of the liquid crystal panel 5B, an amount obtained by multiplying the payout amount corresponding to the winning combination with the bet amount is added and displayed on the point display portion 201.

If a player touches the fight button 202 via the touch panel 101 displayed on the liquid crystal panel 5B, participation in a scrambling game operated by the game server 302 is allowed on condition that point amount currently displayed on the point display portion 201 be bet.

After receiving a notification of participation in a scrambling game from each slot machine 1 within a predetermined time period, the game server 302 matches the other player of the scrambling game in a tournament play. If, at this point, the number of wins needed to survive the tournament becomes unfair when only the slot machines 1 from which a participation notification is received are matched, the game server 302 itself adds as a participant betting predetermined point amount as many times as necessary until the unfairness is eliminated. Then, the game server 302 causes the liquid crystal panel 5B of each slot machine 1 participating in the scrambling game to display a matching table of the tournament.

FIG. 11 is a diagram exemplifying the matching table of tournament of a scrambling game displayed on the liquid crystal panel 5B. The matching table of tournament shown in FIG. 11 will be described below. According to the matching table of tournament shown in FIG. 11, the slot machine 1 whose identification number is [STATION 3], the slot machine 1 provided with the liquid crystal panel 5B, and the slot machine 1 whose identification number is [STATION 5] are participated in the scrambling game. Further, the game server 302 itself whose identification indicator is [COMPUTER] also participates in the scrambling game to make fair the number of wins needed to survive the tournament.

For the slot machine 1 whose identification number is [STATION 3], [12] indicating that point amount bet by the player thereof is displayed inside an ensign and also a [ghost] character assigned randomly by the game server 302 is displayed.

For the slot machine 1 provided with the liquid crystal panel 5B, [21] indicating that point amount bet by the player thereof is displayed inside an ensign and also a [mummy man] character assigned randomly by the game server 302 is displayed.

For the slot machine 1 whose identification number is [STATION 5], [7] indicating that point amount bet by the player thereof is displayed inside an ensign and also a [Dracula] character assigned randomly by the game server 302 is displayed.

For the game server 302 itself whose identification indicator is [COMPUTER], [13] indicating point amount determined by the game server 302 itself by lottery is displayed inside an ensign and also a [wolfman] character assigned randomly by the game server 302 itself is displayed.

Then, the slot machine 1 whose identification number is [STATION 3] plays against the slot machine 1 provided with the liquid crystal panel 5B in the first round. Also, the slot machine 1 whose identification number is [STATION 5] plays against the game server 302 itself whose identification indicator is [COMPUTER] in the first round. Further, winners of each first round play against each other in the second round and the winner of the second round will be the winner of the tournament.

In this respect, the game server 302 sets winning rates for each match by proportional distribution according to the point amount bet by the player of each slot machine 1. In the first round in which the slot machine 1 whose identification number is [STATION 5] plays against the game server 302 itself whose identification indicator is [COMPUTER], for example, the player of the slot machine 1 whose identification number is [STATION 5] bets [7] points. On the other hand, the game server 302 itself whose identification indicator is [COMPUTER] bets [13] points. Therefore, the winning rate of the slot machine 1 whose identification number is [STATION 5] is set at 35% and that of the game server 302 itself whose identification indicator is [COMPUTER] at 65%.

In this manner, the game server 302 determines the winner of the tournament as the winner of the scrambling game and a loser of each match of the tournament as a loser of the scrambling game while setting the winning rates of each match of the tournament. At this point, the game server 302 causes the liquid crystal panel 5B of each slot machine 1 participating in the scrambling game to display, for example, a screen shown in FIG. 12 to add an effect to the scrambling game.

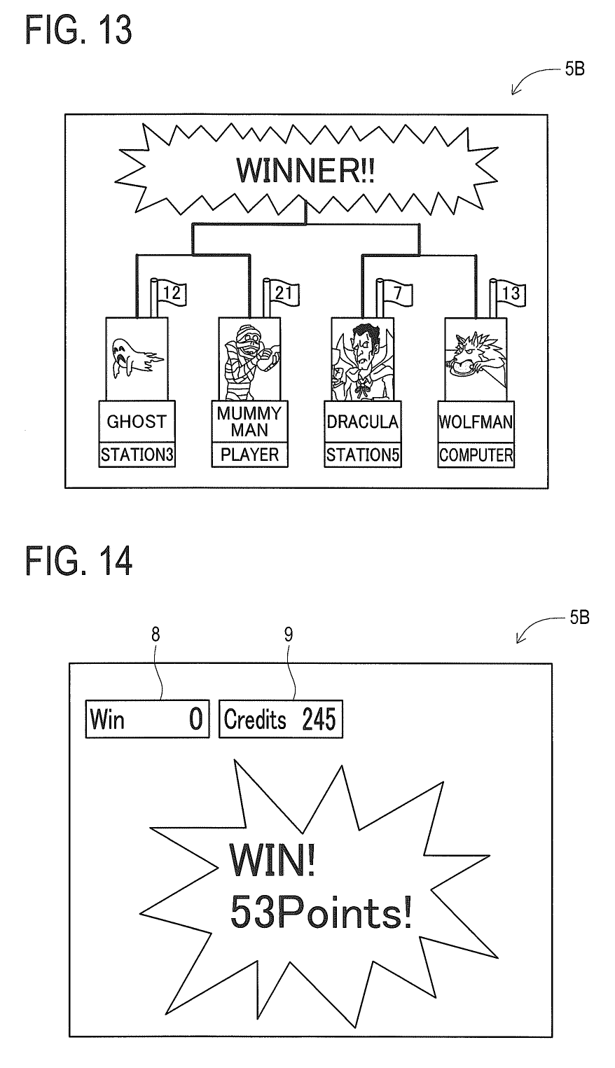

Further, after match results of the tournament are determined, the game server 302 causes the liquid crystal panel 5B of each slot machine 1 participating in the scrambling game to display a matching table of the tournament showing tournament results. FIG. 13 is a diagram exemplifying the matching table of tournament displayed on the liquid crystal panel 5B to show tournament results of a scrambling game.

The matching table of tournament shown in FIG. 13 will be described below. According to the matching table of tournament shown in FIG. 13, the slot machine 1 whose identification number is [STATION 3] has lost the first round. The slot machine 1 provided with the liquid crystal panel 5B has won the first and second rounds to become the winner of the tournament and also the winner of the scrambling game. The slot machine 1 whose identification number is [STATION 5] has won the first round and lost the second round. The game server 302 itself whose identification indicator is [COMPUTER] has lost the first round.

Then, the game server 302 awards the total point amount bet by each participant in the scrambling game to the winner of the scrambling game and confiscates the point amount bet by losers of the scrambling game from them.

According to the matching table shown in FIG. 13, for example, the slot machine 1 provided with the liquid crystal panel 5B is the winner of the scrambling game and thus, in addition to [21] points bet by the player of the slot machine 1 provided with the liquid crystal panel 5B, [12] points bet by the player of the slot machine 1 whose identification number is [STATION 3], [7] points bet by the player of the slot machine 1 whose identification number is [STATION 5], and [13] points determined by the game server 302 itself whose identification indicator is [COMPUTER] by lottery are added and [53] points, which are a total of these points, are awarded to the slot machine 1 provided with the liquid crystal panel 5B. In this case, the game server 302 causes the liquid crystal panel 5B of the slot machine 1 to display a screen as shown in FIG. 14 and awarding of [53] points is made to be displayed with a message [WIN! 53 Points!] being displayed.

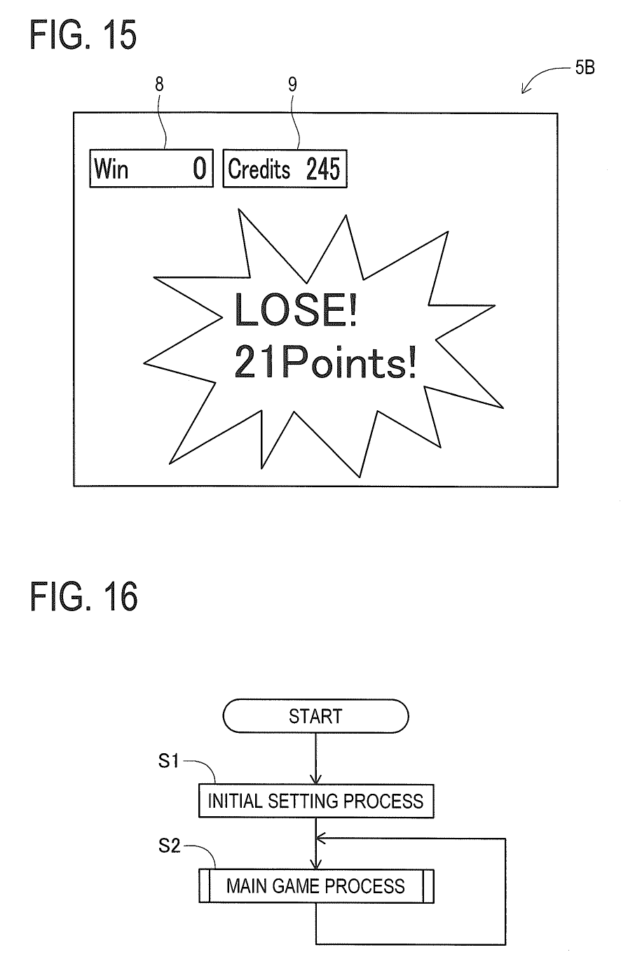

If, on the other hand, the slot machine 1 provided with the liquid crystal panel 5B is a loser of the scrambling game, [21] points bet by the player of the slot machine 1 provided with the liquid crystal panel 5B are confiscated. In this case, the game server 302 causes the liquid crystal panel 5B of the slot machine 1 to display a screen as shown in FIG. 15 and confiscation of [21] points is made to be displayed with a message [LOSE! 21 Points!] being displayed.

[8. Operation of Each Slot Machine]

Next, a main control program executed in each slot machine 1 will be explained with reference to figures. FIG. 16 is a flowchart of the main control program.

First, when the power switch is pressed, the microcomputer 31 is started to operate, an initialization is executed by the microcomputer 31 in step (abbreviated as [S]) 1. In an initial setting process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initial setting process, the verification process to each program is executed.

And in S2, the main CPU 32 reads out the game programs and the like from the RAM 33, and executes the programs in sequence so as to execute a main game process. The game is executed in each slot machine 1 by executing the main game process. And the main game process is repeated in the slot machine 1 when the power is supplied to the slot machine 1.

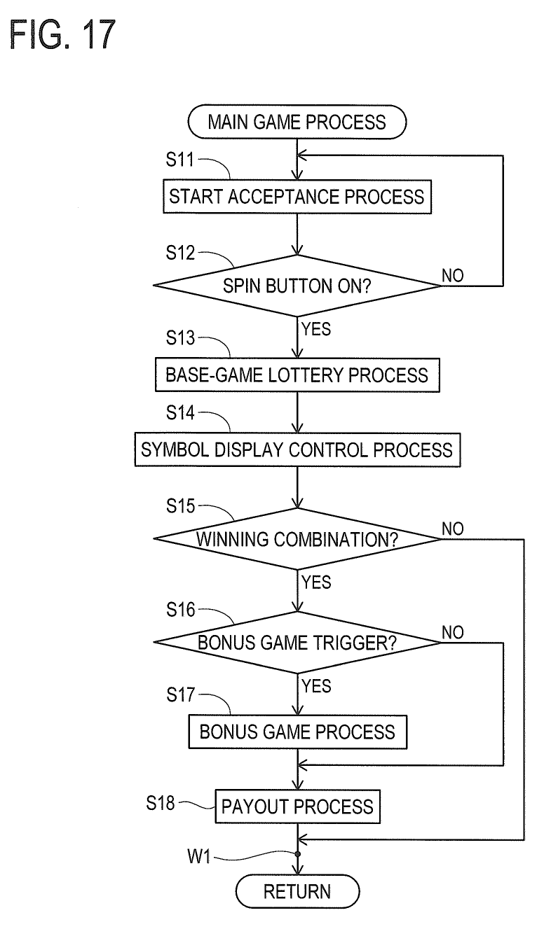

Next, sub process of the main game process in S2 will be explained with reference to FIG. 17. FIG. 17 is a flowchart of the main game process program in each slot machine 1. Also, each program shown in the flowchart of FIG. 17 is stored in the ROM 34 or the RAM 33 of each slot machine 1, and is executed by the main CPU 32.

First, as shown in FIG. 17, a start acceptance process is executed by the main CPU 32 in S11. At this time, in the start acceptance process, the insertion of the coins or the bet operation using the BET button among the operation buttons 11 is executed by the player.

And then, it is determined by the main CPU 32 whether the spin button among the operation buttons 11 is pressed in S12. It is determined based on the input signals corresponding to the button pressing of the operation button 11 to the main CPU 32. Here, when the spin button among the operation buttons 11 is not pressed (S12: NO), the flow returns to the start acceptance process (S11) again. Thereby, it is possible to change the bet amount and the like. On the other hand, when the spin button among the operation buttons 11 is pressed (S12: YES), the bet amount set based on the above bet operation is reduced from the credit amount owned by the player at that time, and is stored in the RAM 33 as bet information. And the credit amount after reduction is also stored in the RAM 33 as credit information. And then, a control signal are transmitted to the display portion driving circuit 67 by the main CPU 32, the credits information stored in the RAM 33 (the above credit amount after reduction) is displayed on the credit display portion 9 of the liquid crystal panel 5B.

In S13, a base-game lottery process is executed by the main CPU 32. Concretely, when the lottery program included in the game programs is executed by the main CPU 32, the random number corresponding to each video reel R1, R2 and R3 respectively is selected from a range of [0] to [255]. And with reference to the symbol weighing data corresponding to the payout rate setting data, based on the three random numbers, the code numbers of the respective video reels R1, R2 and R3 is determined. The determined code numbers of the respective video reels R1, R2 and R3 is stored in the RAM 33 by the main CPU 32, and the flow proceeds to S14.

Here, the code numbers of the respective video reels R1, R2 and R3 are associated with the symbol numbers (symbol numbers shown in FIG. 4) of the symbols which are rearranged on the pay line L of the liquid crystal panel 5B. The main CPU 32 determines the symbol combination in the unit game by determining the code numbers of the respective video reels R1, R2 and R3. For instance, if the symbol numbers of the respective video reels R1, R2 and R3 are set to [21], [21] and [21], the main CPU 32 decides for a symbol combination made up of three [FRANKENSTEIN] symbols (refer to FIG. 4), as the symbol combination in the unit game. Lottery for the symbol combination in the unit game of the slot game is carried out by determining the code numbers of the respective video reels R1, R2 and R3.

When the flow proceeds to S14, a symbol display control process is executed by the main CPU 32. Concretely, first, a reel rotation process is executed by the main CPU 32. In other words, a control signal is transmitted to the sub control board 72 by the main CPU 32, so as to display each video reel R1, R2, and R3 in a rotating manner on each window W1, W2 and W3 of the liquid crystal panel 5B. And then, the effect mode (the display mode of the images on the liquid crystal panel 5B and the sound output mode from the speaker 23) is determined by the main CPU 32, and the sub control board 72 is ordered to start the effect in a predetermined effect pattern.

And then, when the predetermined stop timing to display each video reel R1, R2, and R3 in a rotating manner comes, a reel stop process is executed by the main CPU 32 which transmits control s signal to the sub control board 72. Thereby each video reel R1, R2, and R3 is displayed in a stopping manner, based on the code numbers stored in the RAM 33. Thereby, the symbol combination determined in above S13 is rearranged on the pay line L of the liquid crystal panel 5B.

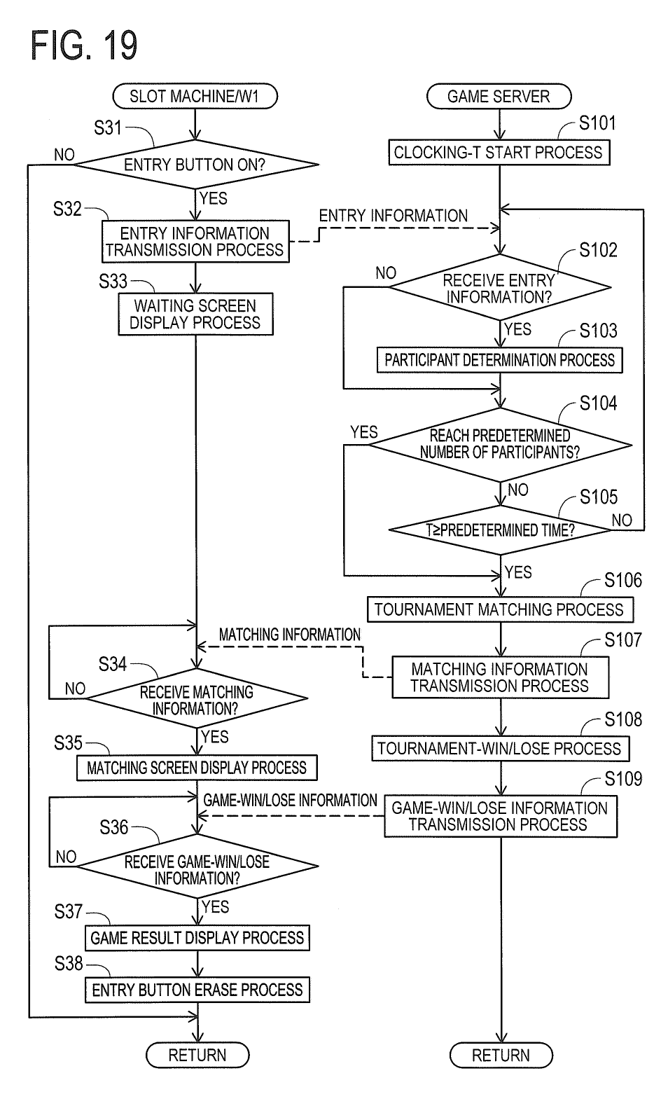

Then, the main CPU 32 proceeds to S15, at which it determines whether or not a winning combination has been realized. This determination is made based on the code numbers of the respective video reels R1, R2 and R3 that were stored in the RAM 33. If a winning combination has not been realized (S15: NO), the flow proceeds to S31 in FIG. 19 as described below. Alternatively, if a winning combination has been realized (S15: YES), the flow proceeds to S16.

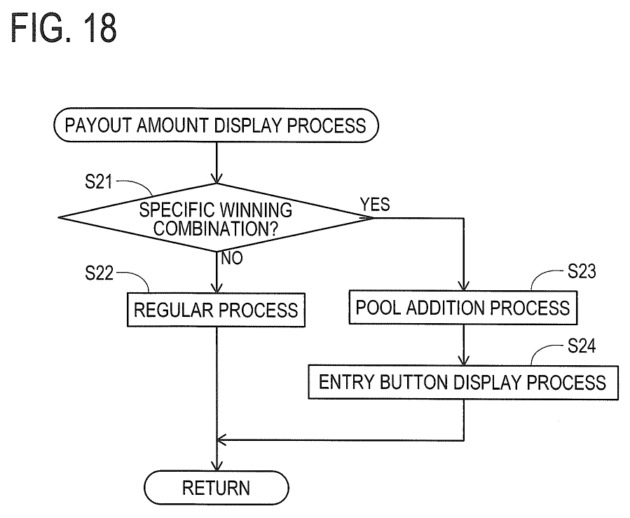

Also, in S15, the main CPU 32 executes a payout amount display process. Accordingly, sub process of the payout amount display process will be described with reference to FIG. 18. FIG. 18 is a flowchart of the payout amount display process program in each slot machine 1. Each of programs shown by the flowchart in FIG. 18 is stored in the ROM 34 or the RAM 33 of each slot machine 1, and executed by the main CPU 32.

More specifically, first, as shown in FIG. 18, the main CPU 32 proceeds to S21, at which it judges whether or not a winning combination which are rearranged on the pay line L of the liquid crystal panel 5B is a particular combination. This determination is made based on the code number that were stored in the RAM 33. Here, the particular combination is the winning combination related to the symbol [CHERRY]. If the particular combination has not been realized (S21: NO), the flow proceeds to S22.

In S22, the main CPU 32 executes a regular process. During the regular process, the main CPU 32 calculates an amount obtained by multiplying the payout amount in accordance with the winning combination rearranged on the pay line L of the liquid crystal panel 5B, with the bet amount. This calculation is made based on the bet information stored in the RAM 33 and the payout table in FIG. 7, the calculated amount is stored in the RAM 33 as payout information. Then, the main CPU 32 displays the payout information (calculated amount) stored in the RAM 33 on the payout amount display portion 8 of the liquid crystal panel 5B, by transmitting a control signal to the display portion driving circuit 67. Then, the flow returns to the main game process of above FIG. 17.

Alternatively, if the particular combination has been realized (S21: YES), the flow proceeds to S23. In S23, the main CPU 32 executes a pool addition process. During the pool addition process, the main CPU 32 calculates an amount obtained by multiplying the payout amount in accordance with the winning combination rearranged on the pay line L of the liquid crystal panel 5B, with the bet amount. This calculation is made based on the bet information stored in the RAM 33 and the payout table in FIG. 7, the calculated amount is stored in the RAM 33 as point information. Then, the main CPU 32 displays the point information (calculated amount) stored in the RAM 33 on the point display portion 201 of the liquid crystal panel 5B, by transmitting a control signal to the display portion driving circuit 67 (refer to FIG. 10). If the point display portion 201 is not displayed on the liquid crystal panel 5B, the main CPU 32 transmits a control signal to the sub control board 72 at the same time so as to display the point display portion 201 on the liquid crystal panel 5B. Then, the flow proceeds to S24.

In S23, the main CPU 32 executes an entry button display process. During the entry button display process, the main CPU 32 transmits a control signal to the sub control board 72 so as to display the fight button 202 on the liquid crystal panel 5B (refer to FIG. 10). If the fight button 202 is already displayed on the liquid crystal panel 5B, the main CPU 32 ignores this S23. Then, the flow returns to the main game process of above FIG. 17.

Then, returning to the main game process of above FIG. 17, the main CPU 32 proceeds to S16, at which it judges whether or not the bonus game trigger is realized. More specifically, if three [FRANKENSTEIN] symbols are rearranged on the pay line L of the liquid crystal panel 5B, it is determined that the bonus game trigger is realized. This determination as well is carried out based on the code numbers of the respective video reels R1, R2 and R3 stored in the RAM 33. If the bonus game trigger is realized (S16: YES), the main CPU 32 executes a bonus game process in S17. Additionally, the slot game is automatically repeated up to the predetermined number of times in the bonus game process, and details thereof are omitted.

After that, the main CPU 32 executes a payout process is S18, including the case when the bonus game trigger is not realized (S16: NO). In the payout process, the payout amount obtained by the player during the slot game and the bonus game (the free game), is awarded to the player respectively, based on the payout information stored in the RAM 33.

When the payout is executed, the credit amount which are stored in the RAM 33 as the payout information (the payout amount obtained by the player in the base game and the bonus game (the free game) respectively) are added to the credit amount stored in the RAM 33 as the credit information by the main CPU 32, and the added value is overwritten in the RAM 33 as the credit information by the main CPU 32. And then, a control signal are transmitted to the display portion driving circuit 67 by the main CPU 32, the credits information stored in the RAM 33 (the added value in S18) is displayed on the credit display portion 9 of the liquid crystal panel 5B. At the same time, [0] is overwritten to the RAM 33 as the payout information by the main CPU 32, and by transmitting a control signal to the display portion driving circuit 67, on the payout amount display portion 8 of the liquid crystal panel 5B, [0] is displayed.

In this payout process, when the player depresses the CASHOUT button among the operation buttons 11, the credit amount which is owned by the current player can be paid out in coins, corresponding to that amount (1 credit corresponding to 1 coin). Alternatively, the credit amount can be paid out through barcode-attached tickets which are printed in the ticket printer 14. Then, after the main CPU 32 executed the payout process in the above S18, the flow proceeds to S31 in FIG. 19 as described below.

[9. Operation of the Gaming System]

After executing the payout process in S18, the main CPU 32 executes each process of S31 to S38 shown in FIG. 19. Thus, each process of S31 to S38 will be described based on FIG. 19. Each program shown by S31 to S38 in FIG. 19 is stored in the ROM 34 or the RAM 33 of each slot machine 1 and executed by the main CPU 32.

If the main CPU 32 determines that there is no winning combination in S15 (S15: NO), the main CPU 32 executes the payout process in S18 and then proceeds to S31 shown in FIG. 19.

In S31, the main CPU 32 determines whether or not a player has touched the fight button 202, which is an entry button. This determination is based on a signal or the like input into the main CPU 32 from the touch panel 101 in accordance with the fight button 202 being touched. Here, if the player has not touched the fight button 202 (S31: NO), the main CPU 32 executes the main game process in FIG. 17 again. If, on the other hand, the player has touched the fight button 202 (S31: YES), the main CPU 32 proceeds to S32.

In S32, the main CPU 32 executes an entry information transmission process. During the entry information transmission process, the main CPU 32 transmits entry information including data for notification of participation of the slot machine 1 in a scrambling game to the game server 302 via the game communication circuit 102. At this point, the main CPU 32 enters point information (point amount) currently stored in the RAM 33 in the entry information. At the same time, the main CPU 32 overwrites the RAM 33 with [0] as point information (point amount). Then, the main CPU 32 proceeds to S33.

In S33, the main CPU 32 executes a waiting screen display process. During the waiting screen display process, the main CPU 32 causes the liquid crystal panel 5B to display a waiting screen (not shown) by transmitting a control signal to the sub control board 72. The waiting screen is an effect screen indicating to the player that a scrambling game has started and the screen shown in FIG. 12 may be made to be displayed as an effect screen thereof. Then, the main CPU 32 proceeds to S34.

In S34, the main CPU 32 determines whether or not matching information has been received from the game server 302. This determination is based on a signal or the like input into the main CPU 32 from the game communication circuit 102 in accordance with matching information being received from the game server 302. Here, the main CPU 32 waits (S34: NO) until matching information is received from the game server 302 and when matching information is received from the game server 302 (S34: YES), the main CPU 32 proceeds to S35.

In S35, the main CPU 32 executes a matching screen display process. During the matching screen display process, the main CPU 32 causes the liquid crystal panel 5B to display a matching screen by transmitting a control signal based on matching information received from the game server 302 to the sub control board 72. The matching screen is, for example, an effect screen shown in FIG. 11 that shows a matching table of tournament of the scrambling game to players. Further, the main CPU 32 adds an effect to show that the scrambling game is being played by causing the liquid crystal panel 5B to display, for example, the screen shown in FIG. 12 by a control signal being transmitted to the sub control board 72. Then, the main CPU 32 proceeds to S36.

In S36, the main CPU 32 determines whether or not game-win/lose information has been received from the game server 302. This determination is based on a signal or the like input into the main CPU 32 from the game communication circuit 102 in accordance with game-win/lose information being received from the game server 302. Here, the main CPU 32 waits (S36: NO) until game-win/lose information is received from the game server 302 and when game-win/lose information is received from the game server 302 (S36: YES), the main CPU 32 proceeds to S37.

In S37, the main CPU 32 executes a game result display process. During the game result display process, the main CPU 32 first causes the liquid crystal panel 5B to display a game result screen by a control signal being transmitted based on the game-win/lose information received from the game server 302 to the sub control board 72. The game result screen is, as shown, for example, in FIG. 13, an effect screen showing a matching table of the tournament in which tournament results of the scrambling game are shown.

Here, if game-win/lose information received from the game server 302 contains data for notification of awarding of the total point amount bet by each participant of the scrambling game, the main CPU 32 causes the liquid crystal panel 5B to display a game win screen by a control signal being transmitted based on the game-win/lose information received from the game server 302 to the sub control board 72. The game win screen is, as shown, for example, in FIG. 14, a message screen showing that point amount have been awarded.

Further, the main CPU 32 adds the point amount contained in the game-win/lose information received from the game server 302 to the credit amount stored in the RAM 33 as credit information and overwrites the RAM 33 with the added value as the credit information. Then, the main CPU 32 causes the credit amount display portion 9 of the liquid crystal panel 5B to display the credit information (the added value determined here) stored in the RAM 33 by a control signal being transmitted to the display portion driving circuit 67.

If, on the other hand, game-win/lose information received from the game server 302 contains data for notification of confiscation of the point amount bet by the player of the slot machine 1 of the scrambling game, the main CPU 32 causes the liquid crystal panel 5B to display a game lose screen by a control signal being transmitted based on the game-win/lose information received from the game server 302 to the sub control board 72. The game lose screen is, as shown, for example, in FIG. 15, a message screen showing that the point amount has been confiscated.

Then, after causing the liquid crystal panel 5B to display the game win screen or game lose screen, the main CPU 32 proceeds to S38 to execute an entry button erase process. During the entry button erase process, the main CPU 32 causes the liquid crystal panel 5B to display a slot game screen as shown in FIG. 8 by a control signal being transmitted to the sub control board 72. At this point, however, the main CPU 32 controls the liquid crystal panel 5B not to display the point display portion 201 and the fight button 202 by a control signal being transmitted to the sub control board 72. Then, the main CPU 32 executes the main game process shown in FIG. 17 again.

In the game server 302, on the other hand, each process of S101 to S109 shown in FIG. 19 is executed. Thus, each process of S101 to S109 will be described based on FIG. 19. Each program shown by S101 to S109 in FIG. 19 is stored in the game server 302 and executed by the game server 302.

The game server 302 first executes a clocking-T start process in S101. During the clocking-T start process, the game server 302 starts clocking of a time T. Then, the game server 302 proceeds to S102.

In S102, the game server 302 determines whether or not entry information has been received from one of the slot machines 1 connected thereto via the network 401. This determination is based on a signal or the like output from the server communication circuit 303 in accordance with entry information being received. Here, if no entry information has been received (S102: NO), the game server 302 proceeds to below S104. If, on the other hand, entry information has been received (S102: YES), the game server 302 proceeds to S103.

In S103, the game server 302 executes a participant determination process. During the participant determination process, the game server 302 stores the slot machine 1 that has transmitted entry information together with the point amount contained in the entry information as a participant of the scrambling game. Then, the game server 302 proceeds to S104.

In S104, the game server 302 determines whether or not the number of slot machines 1 stored as participants of the scrambling game has reached a predetermined number. The predetermined number is preset and may be a constant of one or greater. Here, if the number of slot machines 1 has reached the predetermined number (S104: YES), the game server 302 proceeds to S106 described below. If, on the other hand, the number of slot machines 1 has not reached the predetermined number (S104: NO), the game server 302 proceeds to S105.

In S105, the game server 302 determines whether or not a predetermined time period has passed. This determination is based on the time T at which clocking was started in above S101. Here, if the predetermined time period has not passed (S105: NO), the game server 302 returns to above S102 to repeat processes in S102 and thereafter. If, on the other hand, the predetermined time period has passed (S105: YES), the game server 302 proceeds to S106.

In S106, the game server 302 executes a tournament matching process. During the tournament matching process, the game server 302 randomly determines each match in a tournament play of the scrambling game of each slot machine 1 stored as a participant of the scrambling game in above S103.

At this point, the number of wins needed to survive the tournament may become unfair depending on the number of slot machines 1 stored as participants of the scrambling game in above S103. In such a case, the game server 302 itself adds as a participant of the scrambling game as many times as necessary until the unfairness is eliminated. When the game server 302 itself adds as a participant of the scrambling game, the game server 302 determines the point amount to be bet on the scrambling game by lottery. Further, the game server 302 randomly assigns characters to participants (each slot machine 1 or the game server 302 itself) of the scrambling game to add an effect to the scrambling game.

Then, the game server 302 proceeds to S107 to execute a matching information transmission process. During the matching information transmission process, the game server 302 creates a screen, such as shown in FIG. 11, to show a matching table of the tournament of the scrambling game and returns a control signal to cause the liquid crystal panel 5B to display the screen as matching information to each slot machine 1 that has transmitted entry information.

Then, the game server 302 proceeds to S108 to execute a tournament-win/lose process. During the tournament-win/lose process, the game server 302 sets winning rates for each match by proportional distribution according to the point amount bet by the player of each slot machine 1 and determines a winner/loser of each match based on the set winning rates. Then, the game server 302 determines the winner of the tournament as the winner of the scrambling game and a loser of each match of the tournament as a loser of the scrambling game.

Then, the game server 302 proceeds to S109 to execute a game-win/lose information transmission process. During the game-win/lose information transmission process, the game server 302 creates, based on the results of the process in above S108, a screen, such as shown in FIG. 13, to show a matching table of the tournament in which tournaments results of the scrambling game are shown and returns a control signal to cause the liquid crystal panel 5B to display the screen as game-win/lose information to each slot machine 1 that has transmitted entry information.

At this point, the game server 302 enters data for notification of awarding of the total point amount bet by each participant of the scrambling game in game-win/lose information returned to the winning slot machine 1 of the scrambling game together with data of the total thereof. On the other hand, the game server 302 enters data for notification of confiscation of the point amount bet by the player of the slot machine 1 in the scrambling game in game-win/lose information returned back to the losing slot machine 1 of the scrambling game.

[10. Summary]

As has been described above, in the gaming system 301 according to the present embodiment, the player of each slot machine 1 can participate in a scrambling game in which the game server 302 determines a winner/loser on condition that bet is made on the point amount to be awarded when the winning combination related to the symbol [CHERRY] is rearranged on the pay line L during a slot game.

In this respect, if a player owns the above point amount in each slot machine 1, as shown in FIG. 10, the fight button 202 is displayed on the liquid crystal panel 5B (S24). Then entry information including data for notification of participation in a scrambling game in which the point amount which the player currently owns is bet can be transmitted to the game server 302 (S32) by the fight button 202 being touched by the player via the touch panel 101 (S31: YES).

The game server 302, on the other hand, distributes winning rates in a scrambling game based on the point amount bet by the player of each slot machine 1 (S108). Thus, winning rates in a scrambling game vary depending on the size relation between the point amount bet by a player and the point amount bet by the other player. In this respect, when a winning combination related to the symbol [CHERRY] is rearranged on the pay line L, the point amount bet in a scrambling game by the player of each slot machine 1 are displayed after an amount obtained by multiplying the payout amount corresponding to the winning combination with the bet amount being added to the point display portion 201. Thus, the point amount bet on a scrambling game by the player of each slot machine 1 vary as slot games develop. Therefore, timing to transmit entry information including data for notification of participation in a scrambling game to the game server 302 by the player, that is, timing to touch the fight button 202 via the touch panel 101 is very important in order to be a winner in the scrambling game.

After receiving entry information including data for notification of participation in a scrambling game from each slot machine 1 within a predetermined time period (S105), the game server 302 matches the other player of the scrambling game in a tournament play (S106). However, if the number of wins needed to survive the tournament of the scrambling game becomes unfair, the game server 302 itself adds as a participant betting predetermined point amount when the other player in the scrambling game is matched in the tournament play (S106). Then, the game server 302 determines a winner/loser in each match of the tournament by setting winning rates as described above (S108). Then, only the slot machine 1 that has survived the tournament gets all point amount bet on the scrambling game (S109, S37).

[11. Others]

The present invention is not limited to the above embodiment and can be modified in various ways without deviating from the scope thereof.

For example, the scrambling game may end after only one match. Further, three or more slot machines 1 may participate in the match.

The game server 302 may award a new additional payout amount to the winning slot machine 1 in the scrambling game by lottery.

One of the slot machines 1 connected to the network 401 may be caused to function as the game server 302.

Each screen created by the game server 302 may be created by the slot machine 1 based on information from the game server 302.

What is claimed is:

1. A gaming system, comprising:
game clients constituted by a plurality of slot machines; and
a game server that manages each of the game clients, wherein
each of the game clients has an input device and is programmed to execute the following processes (a) to (c) of:
(a) if a particular winning combination is realized during a slot game, pooling an amount of credit awarded for the particular winning combination as a fight fund separately from other credit and awarding a participation right in a scrambling game in which a total amount of the fight fund is bet;
(b) if data indicating that the participation right is executed is input by a player through the input device, transmitting entry information including a notification of participation of the game client in the scrambling game and the total amount of the fight fund of pooled by the game client to the game server; and
(c) if the following game-win/lose information is received from the game server, calculating the total amount of credit based on the game-win/lose information, and
the game server is programmed to execute the following processes (α) to (ε) of:
(α) if the entry information is received, determining the game client that has transmitted the entry information as a participant of the scrambling game;
(β) if a number of game clients determined by the (α) as participants has reached a predetermined number, matching players of the scrambling game randomly from among game clients determined by the (α) as participants;
(γ) distributing winning rates of the scrambling game proportionately according to an amount of the fight fund contained in the entry information transmitted by each of the game clients matched by the (β) as players of the scrambling game and determining a winner/loser of the scrambling game based on the winning rates for each game client of players of the scrambling game;
(δ) transmitting game-win/lose information notifying that the total amount of the fight fund of a slot machine is confiscated to the slot machine determined by the (γ) as a loser of the scrambling game; and
(ε) transmitting game-win/lose information notifying that the total amount of the fight fund of a slot machine determined by the (γ) as a loser of the scrambling game is awarded to the slot machine determined by the (γ) as the winner of the scrambling game.

2. The gaming system according to claim 1, wherein
each of the game clients is programmed to, when the process (a) is executed, execute the following process (a-1) of:
(a-1) executing an addition process of a pool of the fight fund.

3. The gaming system according to claim 1, wherein
each of the game clients is programmed to, when the process (a) is executed, execute the following process (a-2) of:
(a-2) including a plurality of particular winning combinations realized during the slot game and varying a credit amount that is awarded for each of the particular winning combinations.

4. The gaming system according to claim 1, wherein
the game server is programmed to, when the process of (β) is executed, further execute the following processes (β-1) and (β-2) of:
(β-1) matching players of the scrambling game in a tournament play; and
(β-2) if a number of wins needed to survive a tournament of the scrambling game becomes unfair, adding the game server itself as a participant of the scrambling game including a predetermined amount as the fight fund.
